(19) United States
(12) Patent Application Publication
(10) Pub. No.: US 2025/0317800 A1
(43) Pub. Date: Oct. 9, 2025

(54) INFORMATION PROCESSING METHOD AND COMMUNICATION DEVICE

(71) Applicant: VIVO MOBILE COMMUNICATION CO., LTD., Guangdong (CN)

(72) Inventors: Yannan YUAN, Guangdong (CN); Xiaowen SUN, Guangdong (CN)

(21) Appl. No.: 19/243,191

(22) Filed: Jun. 19, 2025

Related U.S. Application Data
(63) Continuation of application No. PCT/CN2023/139725, filed on Dec. 19, 2023.

(30) Foreign Application Priority Data
Dec. 22, 2022 (CN) 202211659234.8

(51) Int. Cl. H04W 28/084; H04W 28/08

(52) U.S. Cl. CPC H04W 28/084; H04W 28/0967

(57) ABSTRACT

This application discloses an information processing method and a communication device. The information processing method according to an embodiment of this application includes: sending, by a first node to a non-mobile-communication-network function node, service information and computing load information of a service provided by a mobile-communication-network function node, the service information and the computing load information being used by the non-mobile-communication-network function node to determine a service node.

### CROSS-REFERENCE TO RELATED APPLICATIONS

This application is a continuation application of PCT International Application No. PCT/CN2023/139725 filed on Dec. 19, 2023, which claims priority to Chinese Patent Application No. 202211659234.8 filed in China on Dec. 22, 2022, which are incorporated herein by reference in their entireties.

### TECHNICAL FIELD

This application relates to the field of communication technologies, and in particular, to an information processing method and a communication device.

### BACKGROUND

When 6^{th} generation (6G) is an information system that integrates communication, computing, and storage, computing services potentially provided by a mobile network may be online conferencing, simultaneous interpretation, a virtual digital human, augmented reality (AR)/virtual reality (VR), artificial intelligence (AI) model training, AI reasoning, image recognition, video rendering, and the like. In the related art, a 5^{th} generation (5G) protocol does not relate to service information and computing load information of the computing. However, in the related art, Internet engineering task force (IETF) compute first networking (CFN) or a computing-aware networking (CAN) mainly integrates wired network transmission from the perspective of a transmission bearer network, and a service providing node mainly considers an edge computing (Multi-Access Edge Computing, MEC) node connected to a wired transmission device such as a router. Based on service information and computing load information that are obtained by a router or a network controller, when a flow initiates a request, the router or the controller selects a service node only according to resources and states of different service instances in the wired transmission network and routing overhead. However, service information provided by a mobile-communication-network function node and corresponding computing load information are not taken into account. In addition, transmission performance of a mobile network, as part of transmission, also affects quality of a computing/storage service. Therefore, when a mobile communication network provides services such as a computing service and a storage service, how to share the service information and the computing load information that are provided by the mobile-communication-network function node with a mobile network external node (for example, a CFN/CAN node) is a problem that needs to be resolved.

### SUMMARY

Embodiments of this application provide an information processing method and a communication device.

According to a first aspect, an information processing method is provided, including:
sending, by a first node to a non-mobile-communication-network function node, service information and computing load information of a service provided by a mobile-communication-network function node, the service information and the computing load information being used by the non-mobile-communication-network function node to determine a service node.

According to a second aspect, an information processing method is provided, including:
acquiring, by a non-mobile-communication-network function node, service information and computing load information of a service provided by a mobile-communication-network function node that are sent by a first node; and
determining, by the non-mobile-communication-network function node, a service node according to the service information and the computing load information.

According to a third aspect, an information processing apparatus is provided, including:
a first sending module, configured to send, to a non-mobile-communication-network function node, service information and computing load information of a service provided by a mobile-communication-network function node, the service information and the computing load information being used by the non-mobile-communication-network function node to determine a service node.

According to a fourth aspect, an information processing apparatus is provided, including:
a first acquisition module, configured to acquire service information and computing load information of a service provided by a mobile-communication-network function node that are sent by a first node; and
a first determination module, configured to determine a service node according to the service information and the computing load information.

In a fifth aspect, a terminal is provided. The terminal includes a processor and a memory. The memory stores a program or an instruction executable on the processor. When the program or the instruction is executed by the processor, steps of the method as described in the first aspect are implemented.

In a sixth aspect, a terminal is provided, including a processor and a communication interface, where the communication interface is used for sending, to a non-mobile-communication-network function node, service information and computing load information of a service provided by a mobile-communication-network function node, the service information and the computing load information being used by the non-mobile-communication-network function node to determine a service node; or the communication interface is used for acquiring service information and computing load information of a service provided by a mobile-communication-network function node that are sent by a first node; and the processor is configured to determine a service node according to the service information and the computing load information.

In a seventh aspect, a network-side device is provided. The network-side device includes a processor and a memory. The memory stores a program or an instruction executable on the processor. When the program or the instruction is executed by the processor, steps of the method as described in the first aspect or the second aspect are implemented.

In an eighth aspect, a network-side device is provided, including a processor and a communication interface, where the communication interface is used for sending, to a non-mobile-communication-network function node, service information and computing load information of a service provided by a mobile-communication-network function node, the service information and the computing load information being used by the non-mobile-communication-network function node to determine a service node; or the communication interface is used for acquiring service information and computing load information of a service provided by a mobile-communication-network function node that are sent by a first node; and the processor is configured to determine a service node according to the service information and the computing load information.

In a ninth aspect, an information processing system is provided, including: a first node and a non-mobile-communication-network function node, where the first node may be configured to perform steps of the method as described in the first aspect, and the non-mobile-communication-network function node may be configured to perform steps of the method as described in the second aspect.

In a tenth aspect, a readable storage medium is provided. The readable storage medium has a program or an instruction stored therein. When the program or the instruction is executed by a processor, steps of the method as described in the first aspect are implemented, or steps of the method as described in the second aspect are implemented.

In an eleventh aspect, a chip is provided. The chip includes a processor and a communication interface. The communication interface is coupled to the processor. The processor is configured to run a program or an instruction to implement the method as described in the first aspect or the method as described in the second aspect.

In a twelfth aspect, a computer program/program product is provided. The computer program/program product is stored in a storage medium. The computer program/program product is executed by at least one processor to implement steps of the method as described in the first aspect or the second aspect.

### BRIEF DESCRIPTION OF THE DRAWINGS

FIG. 1 is a structural diagram of an applicable communication system according to an embodiment of this application;

FIG. 2 shows a control plane procedure of acquiring service information and computing-power information associated with a CFN node;

FIG. 3 shows a data plane procedure of acquiring service information and computing-power information associated with a CFN node;

FIG. 4 is a schematic flowchart I of an information processing method according to an embodiment of this application;

FIG. 5 is an interaction flowchart I of an information processing method according to an embodiment of this application;

FIG. 6 is an interaction flowchart II of an information processing method according to an embodiment of this application;

FIG. 7 is an interaction flowchart III of an information processing method according to an embodiment of this application;

FIG. 8 is a schematic flowchart II of an information processing method according to an embodiment of this application;

FIG. 9 is a schematic diagram I of modules of an information processing apparatus according to an embodiment of this application;

FIG. 10 is a schematic diagram II of modules of an information processing apparatus according to an embodiment of this application;

FIG. 11 is a structural block diagram of a communication device according to an embodiment of this application;

FIG. 12 is a structural block diagram of a terminal according to an embodiment of this application;

FIG. 13 is a structural block diagram I of a network-side device according to an embodiment of this application; and

FIG. 14 is a structural block diagram II of a network-side device according to an embodiment of this application.

### DETAILED DESCRIPTION

The technical solutions in the embodiments of this application are clearly described below with reference to the accompanying drawings in the embodiments of this application. Apparently, the described embodiments are merely some rather than all of the embodiments of this application. Based on the embodiments in this application, all other embodiments obtained by a person of ordinary skill in the art fall within the protection scope of this application.

The terms such as “first” and “second” in the specification and claims of this application are intended to distinguish similar objects, but are not intended to describe a specific order or sequence. It will be appreciated that the terms used in this way are exchangeable in a proper case, so that the embodiments of this application can be implemented in an order different from the order shown or described herein, and objects distinguished by “first” and “second” are usually of a same category and the number of the objects is not defined. For example, there may be one or more first objects. In addition, the expression “and/or” in the specification and claims represents at least one of connected objects, and the character “/” generally represents that the associated objects are in an “or” relationship.

It should be noted that, the technology described in the embodiments of this application is not limited to a long term evolution (LTE)/LTE-Advanced (LTE-A) system, but may be further used in other wireless communication systems, such as code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” in the embodiments of this application are usually interchangeably used, and the technologies described may be applied to the systems and radio technologies mentioned above, and may also be applied to other systems and radio technologies. The following description describes a new radio (NR) system for illustration, and NR terminology is used in most of the following descriptions, but these technologies may also be applied to applications other than NR system applications, such as 6G communication systems.

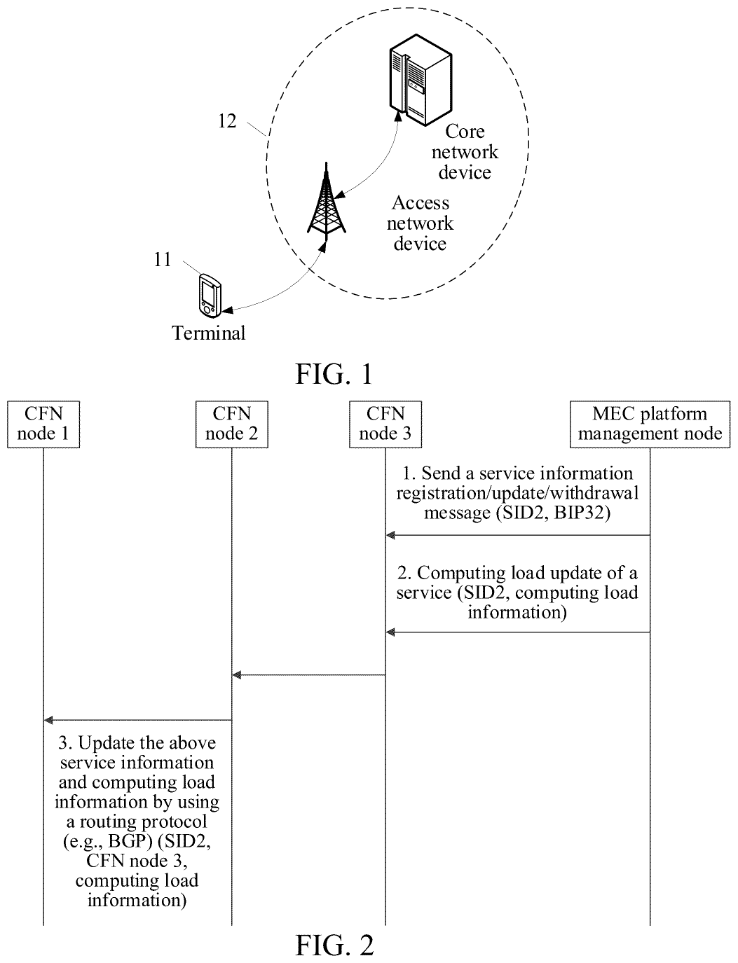

FIG. 1 is a block diagram of an applicable wireless communication system according to an embodiment of this application. The wireless communication system includes a terminal 11 and a network-side device 12. The terminal 11 may be a terminal-side device, such as a mobile phone, a tablet personal computer, a laptop computer or referred to as a notebook computer, a personal digital assistant (PDA), a palm computer, a netbook, an ultra-mobile personal computer (UMPC), a mobile Internet device (MID), an AR/VR device, a robot, a wearable device, vehicle user equipment (VUE), pedestrian user equipment (PUE), smart home (home devices with a wireless communication function, such as a refrigerator, a television, a washing machine, or furniture), a game machine, a personal computer (PC), a teller machine, or a self-service machine. The wearable device includes: a smart watch, a smart band, a smart headset, smart glasses, smart jewelry (a smart bracelet, a smart hand chain, a smart ring, a smart necklace, a smart bangle, a smart anklet, and the like), a smart wrist strap, a smart dress, and the like. It should be noted that a specific type of the terminal 11 is not limited in this embodiment of this application. The network-side device 12 may include an access network device or a core network (CN) device. The access network device may alternatively be referred to as a radio access network device, a radio access network (RAN), a RAN function, or a radio access network unit. The access network device may include a base station, a wireless local area network (WLAN) access point, or a wireless fidelity (WiFi) node, and the like. The base station may be referred to as a node B, an evolved node B (eNB), an access point, a base transceiver station (BTS), a radio base station, a radio transceiver, a basic service set (BSS), an extended service set (ESS), a home node B, a home evolved node B, a transmission reception point (TRP), or some other suitable terms in the field, as long as the same technical effect is achieved. The base station is not limited to specific technical terms. It should be noted that the base station in the NR system is used only as an example for description in the embodiments of this application, but a specific type of the base station is not limited. The CN device may include, but is not limited to, at least one of the following: a CN node, a CN function, a mobility management entity (MME), an access and mobility management function (AMF), a session management function (SMF), a user plane function (UPF), a policy control function (PCF), a policy and charging rules function (PCRF), an edge application server discovery functions (EASDF), unified data management (UDM), unified data repository (UDR), a home subscriber server (HSS), centralized network configuration (CNC), a network repository function (NRF), a network exposure function (NEF), a local NEF (L-NEF), a binding support function (BSF), an application function (AF), and the like. It should be noted that the CN device in the NR system is used only as an example for description in the embodiments of this application, but a specific type of the CN device is not limited.

To enable a person skilled in the art to better understand the embodiments of this application, the following descriptions are first provided.

1. In the 6G era, a network is no longer a simple communication network, but is an information system integrating communication, computing, and storage. Endogenous computation is achieved internally, and computing services are provided externally, thereby reshaping a communication network paradigm. To meet requirements for new network services and lightweight and dynamic computing in the future, network-computing integration has become a new development trend. Under the macro-trend of deep network-computing integration, a core requirement of network evolution requires mutual awareness and high-level coordination between a network and computing. A computing-power network will achieve ubiquitous computing interconnectivity, enabling efficient cloud-network-edge coordination to enhance utilization efficiency of network resources and computing resources, thereby implementing:
(1) Real-time and accurate computing-power discovery: Awareness of a network state and a computer-power position is performed in real time based on a network layer. Regardless of conventional centralized computing power or other computing power distributed in the network, the computing-power network may be combined with real-time information to implement rapid computing-power discovery and routing.
(2) Flexible and dynamic service scheduling: Based on a service level agreement (SLA) requirement of the user, the network comprehensively considers a real-time network resource state and a real-time computing resource state, and by using flexible and dynamic network scheduling, service traffic is quickly matched with an optimal node, allowing the network to support providing a dynamic service to ensure user experience of the service.
(3) Consistency of user experience: Since the computing-power network can be aware of ubiquitous computing and services, the user does not need to care about positions and deployment states of computing resources in the network. Network-computing coordinated scheduling ensures that users obtain consistent experience.

2. IETF CFN:

The IETF CFN is oriented to integration of bearer networks and computing-power services. In view of dynamic changes in computing power provided by a plurality of MEC nodes connected to different transmission devices (such as routers), the IETF CFN has studied and proposed a solution for integration of wired transmission and computing power. According to the solution, how to acquire service information and computing-power information associated with a CFN node is resolved in a transmission bearer network, and selection and routing of a service node are performed based on service information, computing-power information, and transmission overhead.

FIG. 2 shows a control plane procedure. Service information and computing-power information associated with a CFN node are acquired by using the procedure. The CFN node in the figure may be a router. Using a CFN node 3 in FIG. 2 as an example, a MEC platform management node connected to the CFN node 3 sends service information registration/update/withdrawal to the CF node 3. The information includes at least a service identification (service ID, SID) and a binding ID/IP (BID/BIP). The SID is a unique ID for identifying a service, and may be an anycast address (for example, one type of Internet protocol (IP) address in IPv6 is an anycast address). The BID/BIP is used for accessing a particular service instance, and may be a unicast address. That is, if different MECs provide a same service, an SID of the same service is identical, but service instances of different MECs have different BIDs/BIPs. In addition, the MEC platform management node sends a computing load update of the service to the CFN node 3, including the SID and computing load information. The computing load information includes a central processing unit (CPU) used, a number of sessions being served, a quantity of queries per second, a computation delay, and the like. According to a configured range, the CFN node 3 may update the service information and the computing load information to other CFN nodes (such as CFN node 1 and node 2) within the configured range by using a routing protocol (such as a border gateway protocol (BGP)). The service includes an SID, and a CFN node ID (the CFN node 3) that may be routed to the SID, and the computing load information. For the CFN node 1 and node 2, service information and computing load information associated with the CFN node 1 and node 2 are sent to other nodes within the configured range by using the same procedure. After a plurality of CFN nodes share information with each other, each CFN node obtains all service information and computing load conditions within the configured range. To prevent frequent updating of the service and the computing load information, especially the computing load information, between the CFN nodes, a computing load metric threshold or a timer may be set, and updating is performed only when the threshold is exceeded or the timer expires. Another method is a most appropriate egress node selection method, that is, selecting an egress with a relatively low computing load, to prevent fluctuations.

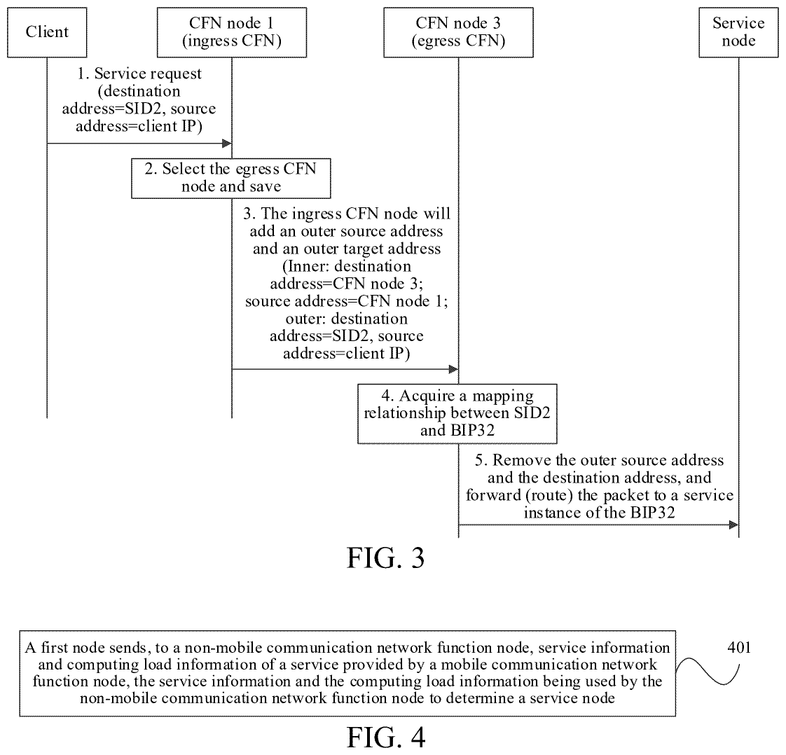

FIG. 3 shows a data plane procedure. When a client (for example, an application (APP) on a user equipment (UE)) initiates a first request of a flow, a destination address of the request is an SID (which may be an anycast IP address of the service obtained by using a domain name system (DNS)), and a source address is an IP of the client. The destination address of the request is identified as an SID, and an egress CFN node (CFN egress) is selected according to service information and computing load information obtained. An ingress CFN node (ingress) is the first CFN node receiving a data request, and the egress CFN node is a CFN node performing routing to a selected target service node. After the egress CFN node is selected, the ingress CFN node will add an outer source address and a target address. The source address is the ingress CFN node (an IP address of the CFN node 1), and the target address is the egress CFN node (an IP address of the CFN node 3). After receiving the IP packet, the CFN node 3 removes outer source and destination IPs according to a mapping relationship between an SID2 and a BIP32 obtained by the CFN node 3, and forwards (routes) the packet to a service instance of the BIP32. A service response is a reverse process of the foregoing, and details are not described herein again.

3. IETF CAN:

CAN, which is currently in a bus-off (BOF) state, has a same basic method as the CFN. A dynamic router (D-Router) is a node supporting a dynamic anycast function. That is, the D-Router can understand network-related metrics and service-instance-related metrics, make a forwarding decision based on instance affinity, and maintain the instance affinity, that is, forward packets belonging to a same service requirement to a same instance. The affinity may be referred to as flow affinity or instance affinity, which means that data packets from a same service “flow” should always be sent to a same egress and be processed by a same service instance. Typically, a flow is identified by using a 5-tuple value (a source IP, a destination IP, a source port number, a destination port number, and a protocol). A dyncast metric agent (D-MA) is a dyncast specific agent, and can collect and send metric updates from networks and instances, but does not perform a forwarding decision. The D-MA may run on the D-Router, or may be implemented as a standalone module (for example, a software library) co-located with service instances. Compared with the service information and the computing load information shared by the foregoing CFN nodes, service information and computing load information shared by the D-MA include a dyncast service ID (D-SID), a dyncast binding ID (D-BID), and metrics. The D-SID, the D-BID, and the metrics have meanings respectively similar to those of the SID, the BID/BIP, and the metrics of the foregoing CFN. As can be seen, the D-MA directly shares a service instance ID (that is, the D-BID) rather than a router ID (a CFN node ID or a D-router ID).

For a distributed mode, resources and states of different service instances are propagated from a D-Router connected to an edge site deploying a service to a D-Router connected to the client. In addition, the D-Router also collects network topology and state information. An ingress D-Router receiving a client service request independently determines, according to a service instance state and a network state, which service instance to access, and maintains instance affinity. For a centralized mode, resources and states of different service instances are reported to a network controller from the D-Router connected to the edge site deploying the service. At the same time, the controller collects network topology and state information. The controller makes a routing decision for each ingress D-Router according to the service instance state and the network state, and downloads a decision to all ingress D-Routers.

The following describes in detail the information processing method provided in the embodiments of this application by using some embodiments and application scenarios thereof with reference to the accompanying drawings.

As shown in FIG. 4, an embodiment of this application provides an information processing method, including the following steps:

Step 401: A first node sends, to a non-mobile-communication-network function node, service information and computing load information of a service provided by a mobile-communication-network function node, the service information and the computing load information being used by the non-mobile-communication-network function node to determine a service node.

The first node in this embodiment of this application includes a control plane node (for example, an SMF) or a user plane node (for example, a UPF) in a mobile communication network. The service node may be a mobile-communication-network function node or may be a non-mobile-communication-network function node.

The mobile-communication-network function node includes an IP multimedia subsystem (IMS), a trusted data network (DN) node, a CN function node, a RAN node, and a UE.

In this embodiment of this application, the first node sends, to the non-mobile-communication-network function node, the service information and the computing load information of the service provided by the mobile-communication-network function node, which achieves a purpose of sharing the service information and the computing load information that are provided by the mobile-communication-network function node with an mobile network external node, so that the non-mobile-communication-network function node no longer selects a service node based on only service information and computing load information of a service provided by the non-mobile-communication-network function node, but can select a more appropriate service node based on the service information and the computing load information of the service provided by the mobile-communication-network function node and the service information and the computing load information of the service provided by the non-mobile-communication-network function node. That is, the selection of the service node integrates the service information and the computing load information corresponding to two networks, i.e., a mobile communication network and a non-mobile communication network. A service provided by the service node may be the service provided by the mobile-communication-network function node or may be the service provided by the non-mobile-communication-network function node.

Optionally, the service information includes at least one of the following:
at least one of a service ID and a service instance ID, where the service ID is used for identifying a service, and a client accesses the service by using the service ID; the service instance ID is used for identifying a service instance providing the service, and the service instance corresponds to the service node;
and/or, the computing load information includes at least one of the following:
a load value;
a metric parameter corresponding to the load value;
a service available time; where the service available time may be a relative time or an absolute time, for example, the relative time is one hour after a protocol data unit (PDU) session is established or a request is updated, for example, the absolute time is 00:00 to 00:05, or the like; and
a service available region. The service available region may be represented by a defined distinguishing ID in a network such as a tracking area (TA), a RAN, or a cell, or by coordinates of a geographical location.

In this embodiment of this application, the foregoing service ID may be an anycast IP address, or may be a predefined service ID (for example, a particular IPv4 address negotiated by the service node, the router, and the first node; and in another example, a medium access control (MAC) address or the like).

The service instance ID may be a unicast IP address (for example, an internal IP address of a UE, an external IP address of the UE, or an IP address of an IMS server), or may be a MAC address, or may be an IP address, a port number, or the like.

The metric parameter may include at least one parameter or a plurality of parameters, such as a CPU occupancy rate, a CPU idle rate, a service session occupancy rate, a service session idle rate, a quantity of used CPUs, a quantity of available CPUs, a quantity of used CPU cores, a quantity of available CPU cores, a quantity of used sessions, a quantity of available sessions, a computing delay, and used computing resources or available computing resources measured in Turing units, hash rates, tera operations per second (TOPS)/giga operations per second (GOPS)/million operations per second (MOPS), floating-point operations per second (FLOPS), or the like.

The above metric parameter may alternatively be a parameter, and a load value corresponding to the parameter may be a value obtained by performing weighting calculation on load values corresponding to a plurality of parameters. For example, the metric parameter may be a single digital value, for example, a picture recognition service, calculated from a weighted attribute (such as CPU/graphics processing unit (GPU) consumption and/or a quantity of related sessions). A service provider may define a service load digital value by integrating bandwidth resources, a quantity of requests, and computing resources.

It should be noted that according to different designs, generally, a service may be deployed on one or more servers. Typically, a server has a plurality of CPUs, and a CPU has a plurality of CPU cores.

Turing unit: The Turing Fog Foundation defines a globally pioneering objective computing power measurement unit for production nodes: Turing unit (TU), and 24-hour computing of a GPU 1080 Ti is defined as 1TU, which is used as a measurement benchmark. A market price corresponding to 1TU is 25 RMB. Therefore, a computing-power value corresponding to 1TU is 25 RMB.

Hash rate: Computing power (also referred to as a hash rate) is a measurement unit of a network processing capability, that is, a speed at which a computer (CPU) calculates an output of a hash function. The network needs to perform intensive mathematical and encryption-related operations for security purposes. For example, when the network reaches a hash rate of 10 Th/s, it means that the network may perform 10 trillion calculations per second.

TOPS/GOPS/MOPS: A processor computing capability unit. 1TOPS represents that the processor may perform one trillion (10¹²) operations per second. TOPS/GOPS/MOPS is generally used as a CPU computing power metric. 1GOPS represents that the processor may perform one billion (10⁹) operations per second, and 1MOPS represents that the processor may perform one million (10⁶) operations per second.

Optionally, the method in this embodiment of this application further includes:
sending, by the first node, at least one of network topology structure information and a network transmission state of a mobile communication network to the non-mobile-communication-network function node;
where the network topology structure information is information of a network topology structure between the mobile-communication-network function node providing the service and the first node.

The foregoing network transmission state may alternatively be described as network overhead or transmission overhead between the first node in the mobile communication network and the mobile-communication-network function node providing the service.

Optionally, in a case that the mobile-communication-network function node providing the service is a terminal device:
the network topology structure information includes at least one of the following: a serving base station (servicing RAN node) of the terminal device; a target node (for example, a UPF) transmitting a first PDU session; where the first PDU session is a PDU session corresponding to a service request;
and/or the network transmission state includes at least one of the following:
an uplink transmission delay between the terminal device and the base station;
a downlink transmission delay between the terminal device and the base station;
a round-trip transmission delay between the terminal device and the base station;
an uplink transmission delay between the base station and the target node;
a downlink transmission delay between the base station and the target node;
a round-trip transmission delay between the base station and the target node;
an uplink bandwidth between the terminal device and the base station;
a downlink bandwidth between the terminal device and the base station;
an uplink bandwidth between the terminal device and the target node; and
a downlink bandwidth between the terminal device and the target node;
where the target node is a node that receives service data sent by a service request sending node. The target node may alternatively be described as a node that performs forwarding processing on a data packet of a service flow.

It should be noted that, based on a 5G network, a computing service is based on a user plane bearer. Therefore, a transmission path of a user-equipment-related computing service in the network includes a base station and a UPF. If 6G-oriented expansion is considered, the base station still generally represents a radio access network node, and the UPF may be extended to a computing service bearer function in a CN (such as a computing plane function or a data plane function discussed in 6G).

Optionally, the service data includes a service request, and the service request may be a first data packet of the service data.

Optionally, in a case that the mobile-communication-network function node providing the service is an IMS function node, a trusted DN node, a CN network function node, or a RAN network function node:
the network topology structure information includes: the first node connected to the mobile-communication-network function node providing the service;
and/or the network transmission state includes at least one of the following:
an uplink transmission delay between a target node and the mobile-communication-network function node providing the service;
a downlink transmission delay between the target node and the mobile-communication-network function node providing the service; and
a round-trip transmission delay between the target node and the mobile-communication-network function node providing the service;
where the target node is a node that receives service data sent by a service request sending node.

It should be noted that an uplink delay between the target node and the mobile-communication-network function node providing the service is a delay in a case that the mobile-communication-network function node providing the service performs sending and the target node performs receiving; and a downlink delay between the target node and the mobile-communication-network function node providing the service is a delay in a case that the target node performs sending and the mobile-communication-network function node providing the service performs receiving.

Similarly, an uplink bandwidth between the target node and the mobile-communication-network function node providing the service is a bandwidth in a case that the mobile-communication-network function node providing the service performs sending and the target node performs receiving; and a downlink bandwidth between the target node and the mobile-communication-network function node providing the service is a bandwidth in a case that the target node performs sending and the mobile-communication-network function node providing the service performs receiving.

It should be noted that the delay mentioned in the foregoing description may be real-time delay measurement information, or may be historical delay information, or may be delay information in a future period of time predicted based on historical data. The foregoing items may be a maximum delay, a minimum delay, a delay average value, and the like.

Optionally, the method in this embodiment of this application further includes:
acquiring, by the first node, the service information and the computing load information of the service provided by the mobile-communication-network function node.

As an optional implementation, the acquiring, by the first node, the service information and the computing load information of the service provided by the mobile-communication-network function node includes:
acquiring, by the first node from a second node, the service information and the computing load information of the service provided by the mobile-communication-network function node, the second node being the mobile-communication-network function node, and the first node being different from the second node.

Optionally, the acquiring, by the first node, the service information and the computing load information of the service provided by the mobile-communication-network function node includes:
acquiring, by the first node, the service information and the computing load information by using an extended session management message, for example, a PDU session establishment message or a PDU session modification message;
or acquiring, by the first node, the service information and the computing load information by using a service registration message, a service update message, a service deregistration message, or a service withdrawal message.

Optionally, the sending, by a first node to a non-mobile-communication-network function node, service information and computing load information of a service provided by a mobile-communication-network function node includes:
sending, by the first node, the service information and the computing load information to the non-mobile-communication-network function node by using a service registration message, a service update message, a service deregistration message, or a service withdrawal message.

It should be noted that the service registration message in this embodiment of this application is used for registering a service that can be provided by the service node, and the service registration message may include a service ID of a service that needs to be registered.

The service update message is used for updating a registered service, and the message may include information of a related service that needs to be updated, for example, update an ID of a service instance providing the registered service.

The service deregistration message is used for deregistering a registered service, and the message may include a service ID and/or a service instance ID of a service that needs to be deregistered.

The service withdrawal message is used for withdrawing a registered service, and the message may include a service ID and/or a service instance ID of a service that needs to be withdrawn.

Optionally, the method in this embodiment of this application further includes:
sending update information of the computing load information to the non-mobile-communication-network function node according to a load information update condition.

The update information may include a service ID and/or a service instance ID, and computing load information.

The solution of this application is described in detail below with reference to embodiments.

In a first embodiment of this application, the first node is a control plane node such as an SMF, and a node providing a service in the mobile communication network is a UE.

According to a definition of the IETF CFN or CAN, a CFN node, a D-MA, a D-Router co-located with the D-MA, and a network controller may learn service information and computing load information outside a mobile network in a range thereof. When a mobile-communication-network function node (such as an IMS, a trusted DN, and a UE) provides a service, the service information and the computing load information also need to be provided for the CFN node, the D-MA, the D-Router co-located with the D-MA, the network controller, or the like, so that the foregoing nodes can select a more appropriate service node according to information such as computing loads and transmission states of an external network service and an internal network service. The UE mainly refers to a UE having sufficient power and computing power, such as an automobile or a CPE.

In this embodiment, there are two manners in which the first node provides the service information and the computing load information of the service provided by the mobile-communication-network function node. In one method, the first node provides service information and computing information by sending service registration/update/withdrawal information to a transmission device (the CFN node, the D-MA, the D-Router co-located with the D-MA, or the like) connected to the first node. Optionally, a similar method is also applicable to at least one of the network topology structure information and the network transmission state of the mobile communication network. In another method, the first node may report the above information to the network controller. The first node functions as an information reporting agent for a node providing a service in the mobile network. On the one hand, there may be many nodes providing services in the mobile network, and message overhead of service information and computing information updates in a transmission network may be reduced by using aggregation via the first node. On the other hand, the node providing the service in the mobile network may use an internal IP address or the like in the mobile network, and the first node may convert an ID (such as an IP address) of the first node, to support completion of service interaction.

Optionally, before the first node provides the foregoing information, a solution in which the first node acquires the foregoing information is that the UE may carry, by using an extended PDU session establishment or modification message, service information and computing load information provided by the UE.

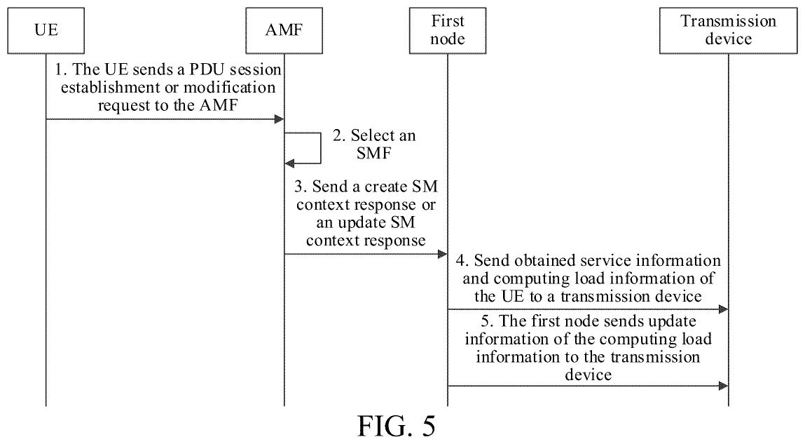

The foregoing procedure is described below based on the 5G PDU session establishment or modification procedure in the related art and FIG. 5.

Step 1: When a UE may provide a service, the UE sends a PDU session establishment or modification request to an AMF.

The PDU session establishment or modification request carries service information and computing load information, and the service information and the computing load information include at least one of the following:
a service ID which is a unique ID that identifies a service, and may be an anycast IP address, or may be a predefined service ID (for example, a particular IPv4 address negotiated by the service node, the router, and the first node; and in another example, a MAC address or the like);
a service instance ID which is a unique ID that identifies a service instance, and may be a unicast IP address (for example, an internal IP address of the UE, an external IP address of the UE, or an IP address of an IMS server), or may be a MAC address, or may be an IP address, a port number, or the like;
a load value and a metric parameter corresponding to the load value, where the metric parameter is described in detail in the foregoing description, and details are not described herein again;
a service available time; and
a service available region.

The service available time and the service available region are both described in detail in the foregoing description, and details are not described herein again.

Step 2: The AMF selects, according to information, an SMF supporting collection of the service information/computing load information.

According to a definition of a network function, the service information/computing load information may alternatively be separately collected and provided by a plurality of network functions for a needed node. For example, the SMF is responsible for collecting and providing service information of the UE, and a UPF (or a new computing service management function) is responsible for collecting and providing computing load information of a service of the UE.

Step 3: The AMF sends a PDU session Create session management (SM) Context or Update SM Context request to the first node (that is, the SMF).

It should be noted that for a procedure of modifying the PDU session after establishment, refer to a protocol in the related art, and this embodiment only shows some content (that is, step 1 to step 3 above).

Step 4: The first node sends obtained service information and computing load information of the UE to a transmission device.

The transmission device may be a controller, a CFN node, a D-MA, or the like. The first node may send one or more pieces of service information and/or computing load information of the UE at a time according to the obtained information. For example, a service registration/update message is sent within an available time interval or an available region in which the UE may provide the service, and a service withdrawal/deregistration message is sent when the UE leaves the service available region or the service available time. In addition, when providing the information of the UE, the first node needs to use a UE ID as a service instance ID provided by each UE. If the transmission device is an external network device, the first node needs to provide the external IP address of the UE as the service instance ID provided by the UE, and the information needs to be provided for a network external function by using a NEF or the like. When the information is provided by using the NEF, an extended definition of event exposure using the NEF is required. An example of the extended definition based on TS 23.502 Table 4.15. 3.1-1: List of events for monitoring capability is shown in Table 1.

TABLE 1

| Event | Detection criteria | Which NF detects the event |
|---|---|---|
| Service reporting | The network detects a state of | First node (e.g., SMF) |
| | service information provided by | |
| | the UE (Note 1), and the non- | |
| | mobile-communication-network | |
| | function node may provide a | |
| | service of interest or may | |
| | provide a maximum quantity of | |
| | registered services | |
| Computing load | The network detects a state of | First node (e.g., SMF) |
| information | service information provided by | |
| reporting | the UE (Note 1), and the non- | |
| | mobile-communication-network | |
| | function node may provide a | |
| | service of interest or may | |
| | provide a maximum quantity of | |
| | registered services | |

(Note 1):
This embodiment is based on an example in which the UE provides a service. Therefore, the UE is also used as a detection object in the network. When an IMS service node, a trusted DN node, a CN function node, or a RAN function node provides a service, a corresponding detection object is the IMS service node, the trusted DN node, the CN function node, or the RAN function node.

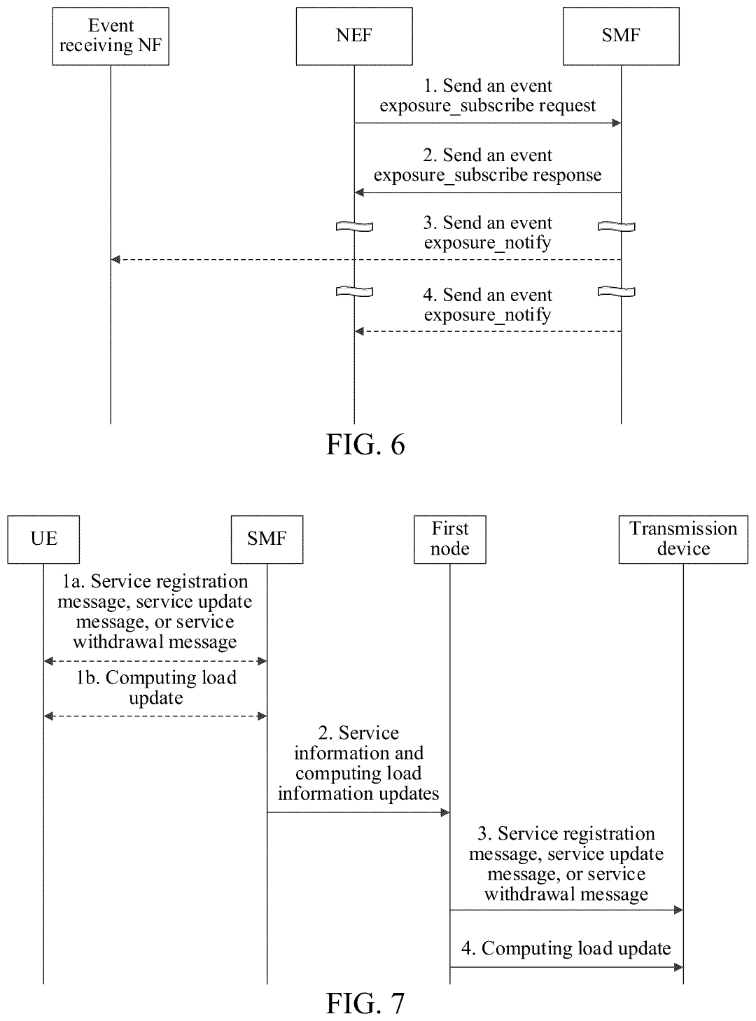

Correspondingly, an example of a service operation information flow of the first node (taking an SMF as an example) is shown in FIG. 6. Related steps are briefly described as follows:

Step 1: The NEF sends an event exposure_subscribe (Nsmf_EventExposure_Subscribe) request, to subscribe to an event ID (a group of event IDs) in the SMF. The NEF may be a same NF that subscribes to receiving an event notification report (that is, an event receiving NF), or may be another NE. The NEF subscribes to one or more events (identified by an event ID), and provides related notification endpoints of the event receiving NF. If the NEF is not the event receiving NF, in addition to providing the notification endpoints (such as a CFN node, a D-router, and a controller) of the event receiving NF, the NEF should further provide notification endpoints thereof. Each notification endpoint is associated with a related event ID (a group of event IDs). This is to ensure that the NEF can receive a notification of a subscription-change-related event (for example, a subscription-related ID change). Event report information defines a required report type. If an event reporting subscription is authorized by the SMF, the SMF may record an association between event triggers and requester identities.

Step 2: The SMF confirms execution of Nsmf_EventExposure_Subscribe and sends an event exposure_subscribe response (Nsmf_EventExposure_Subscribe Response).

Step 3: [Conditional-depending on the Event] The SMF detects that a monitored event occurs, and sends an event report to a notification endpoint of the event receiving NF by using an event exposure notify (Nsmf_EventExposure Notify) message.

Step 4: [Conditional-depending on the Event] The SMF detects that a subscription-change-related event occurs, for example, due to reallocation by the SMF, a subscription-related ID changes, and the SMF sends an event report to the NEF by using the Nsmf_EventExposure Notify message.

Optionally, the first node may further provide internal topology and a network transmission state of a mobile network corresponding to the UE. For example, a delay-reusable SMF delay measurement function simultaneously triggers measurement performed by a serving base station of the UE and a UPF, thereby obtaining a delay from the UE to the serving base station and delay information from the serving base station to the UPF. Similarly, bandwidth information may also be obtained by measurement performed by the serving base station and/or the UPF. When the internal topology and the network transmission state of the mobile network are provided for a network external node, a manner similar to the above manner of providing service information and computing load information externally may be used, that is, being provided by using the NEF.

Step 5: The first node sends update information of the computing load information to the transmission device.

In a second embodiment of this application, the first node is a user plane node such as a UPF, and a node providing a service in the mobile communication network is a UE.

According to a definition of the IETF CFN or CAN, a CFN node, a D-MA, a D-Router co-located with the D-MA, and a controller may learn service information and computing load information outside a mobile network in a range thereof. When a mobile-communication-network function node (such as an IMS, a trusted DN, and a UE) provides a service, the service information and the computing load information also need to be provided for the CFN node, the D-MA, the D-Router co-located with the D-MA, the network controller, or the like, so that the foregoing nodes can select a more appropriate service node according to information such as computing loads and transmission states of an external network service and an internal network service. The UE mainly refers to a UE having sufficient power and computing power, such as an automobile or a CPE.

In this embodiment, it is assumed that the first node is a user plane node, for example, a UPF. A method for the first node to provide service information and computing information is to send the service information and the computing information to the CFN node, the D-MA, the D-Router co-located with the D-MA, or the like based on a routing protocol. Optionally, a similar method is also applicable to at least one of the network topology structure information and the network transmission state of the mobile communication network. In another solution, the UPF may report the above information to the network controller. The first node functions as an information reporting agent for a node providing a service in the mobile network. On the one hand, there may be many nodes providing services in the mobile network, and message overhead of service information and computing information updates in a transmission network may be reduced by using aggregation via the first node. On the other hand, the node providing the service in the mobile network may use an internal IP address or the like in the mobile network, and the first node may convert an ID (such as an IP address) of the first node, to support completion of service interaction.

Optionally, before the first node provides the foregoing information, a method for the first node to acquire the foregoing information is to acquire service information and computing load information of the ULE from the control plane node (e.g., the SMF). In another method, the UE indicates and carries, by using a protocol header of a user plane data packet, the service information and the computing load information provided by the UE.

The foregoing procedure is schematically described below based on the 5G function and procedure in the related art and FIG. 7.

Step 1: When the UE may provide a service, an SM message is sent to the SMF, the SM message carrying service information and computing load information.

The session management message may be a service registration message, a service update message, or a service withdrawal message, and when the computing load information is updated, updated information is sent to the SMF.

The service information and the computing load information are the same as those in the first embodiment, and details are not described herein again.

Step 2: The SMF may send the service information and the computing load information to the UPF based on a timer setting or a time cycle or an event trigger.

The UPF may alternatively subscribe to the service information and the computing load information from the SMF, and when the information is updated, the SMF sends updated information to the UPF.

Step 3: The first node sends obtained service information and computing load information of the UE to a transmission device.

The transmission device may be a controller, a CFN node, a D-MA, or the like. The first node may send one or more pieces of service information and/or computing load information of the UE at a time according to the obtained information. For example, a service registration/update message is sent within an available time interval or an available region in which the UE may provide a service, and a service withdrawal/cancellation message is sent when the UE leaves the service available region or the service available time. In addition, when providing the information of the UE, the first node needs to use a UE ID as a service instance ID provided by each UE. If the transmission device is an external network device, the first node needs to provide the external IP address of the UE as the service instance ID provided by the UE, and the information needs to be provided for a network external function by using a NEF or the like. Optionally, the first node may further provide internal topology and a state of a mobile network corresponding to the UE, and the UPF may also obtain an internal topology structure and a network transmission state of the mobile network from the SMF by using the method for acquiring the service information and the computing load information.

Step 4: The first node sends update information of the computing load information to the transmission device.

In a third embodiment of this application, the first node is a control plane node, for example, a call session control function (CNFC) node or a CN computing service management function, and a service is provided by an IMS node or a trusted DN node. The call session control function mainly completes various session control functions such as establishment, maintenance, and removal of various IMS sessions.

According to a definition of the IETF CFN or CAN, a CFN node, a D-MA, a D-Router co-located with the D-MA, and a controller may learn service information and computing load information outside a mobile network in a range thereof. When a mobile-communication-network function node (such as an IMS, a trusted DN, and a UE) provides a service, the service information and the computing load information also need to be provided for the CFN node, the D-MA, the D-Router co-located with the D-MA, the network controller, or the like, so that the foregoing nodes can select a more appropriate service node according to information such as computing loads and transmission states of an external network service and an internal network service. The UE mainly refers to a UE having sufficient power and computing power, such as an automobile or a CPE.

In this embodiment, it is assumed that the first node is a control plane node, for example, a CSCF, or a new CN network function for computing service management. A method for the first node to provide the information is to provide, by using service registration/update/withdrawal, or the like, service information and computing information for a transmission device connected to the first node (sent to the CFN node, the D-MA, or the D-Router co-located with the D-MA, or the like). Optionally, a similar method is also applicable to internal topology and network transmission state information of a mobile network of the IMS/trusted DN. In another method, the first node may report the above information to the network controller. The first node functions as an information reporting agent for a node providing a service in the mobile network. On the one hand, there may be many nodes providing services in the mobile network, and message overhead of service information and computing information updates in a transmission network may be reduced by using aggregation via the first node. On the other hand, the node providing the service in the mobile network may use an internal IP address or the like in the mobile network, and the first node may convert an ID (such as an IP address) of the first node, to support completion of service interaction.

Optionally, before the first node provides the foregoing information, a solution in which the first node acquires the foregoing information is that the IMS/trusted DN node registers service information, which can be provided, to a first node computing service function. In addition, a computing load update message is sent to the first node according to an agreed computing load update condition (such as based on a timer, an event trigger, or a computing load change threshold). The process may specifically include the following steps:

Step 1: The IMS/trusted DN node sends a service registration/update/deregistration/withdrawal message to the first node.

Optionally, the foregoing message sent in this step belongs to static or semi-static information with respect to the computing load information.

The message includes at least one of the following:
a service ID which is a unique ID that identifies a service, and may be an anycast IP address, or may be a predefined service ID (for example, a particular IPv4 address negotiated by the service node, the router, and the first node; and in another example, a MAC address or the like);
a service instance ID which is a unique ID that identifies a service instance, and may be a unicast IP address (for example, an internal IP address of the UE, an external IP address of the UE, or an IP address of an IMS server), or may be a MAC address, or may be an IP address, a port number, or the like;
a load value and a metric parameter corresponding to the load value, where the metric parameter is described in detail in the foregoing description, and details are not described herein again;
a service available time; and
a service available region.

The service available time and the service available region are both described in detail in the foregoing description, and details are not described herein again.

Step 2: The IMS/trusted DN node sends a computing load update message to the first node, the message including at least one of the following:
a load value and a metric parameter corresponding to the load value, which may be, for simplicity of use, a single digital value, for example, a picture recognition service, calculated from a weighted attribute (such as CPU/GPU consumption and/or a quantity of related sessions), where a service provider may define a service load digital value by integrating bandwidth resources, a quantity of requests, and computing resources; a computing load metric, which may alternatively be a group of parameters, including a CPU occupancy rate, a CPU idle rate, a service session occupancy rate, a service session idle rate, a quantity of used CPUs, a quantity of available CPUs, a quantity of used CPU cores, a quantity of available CPU cores, a quantity of used sessions, a quantity of available sessions, a computing delay, and used computing resources or available computing resources measured in Turing units, hash rates, TOPS/GOPS/MOPS, FLOPS, or the like; and
a service availability indication indicating whether the service is available.

Step 3: The first node sends obtained service information and computing load information of the IMS/trusted DN node to a transmission device.

If the transmission device is an external network device, the first node needs to provide an external IP address of the IMS/trusted DN node as a service instance ID provided by the IMS/trusted DN node, and the information needs to be provided for a network external function by using a NEF or the like. Optionally, the first node may further provide an internal topology structure and a network transmission state of a mobile network corresponding to the IMS/trusted DN.

Optionally, the service information and the computing load information provided by the IMS/trusted DN node may alternatively be provided for the transmission device by using the user plane node. Details are not described in this embodiment again.

In a fourth embodiment of this application, the first node is a control plane node, for example, a new computing service management function added to a CN, and a service is provided by a CN network function node or a RAN function node.

According to a definition of the IETF CFN or CAN, a CFN node, a D-MA, a D-Router co-located with the D-MA, and a controller may learn service information and computing load information outside a mobile network in a range thereof. When a mobile-communication-network function node (such as an IMS, a trusted DN, and a UE) provides a service, the service information and the computing load information also need to be provided for the CFN node, the D-MA, the D-Router co-located with the D-MA, the network controller, or the like, so that the foregoing nodes can select a more appropriate service node according to information such as computing loads and transmission states of an external network service and an internal network service. The UE mainly refers to a UE having sufficient power and computing power, such as an automobile or a CPE.

In this embodiment, it is assumed that the first node is a control plane node, for example, a new CN network function for computing service management. A method for the first node to provide the information is to provide, by using service registration/update/withdrawal, or the like, service information and computing information for a transmission device connected to the first node (sent to the CFN node, the D-MA, or the D-Router co-located with the D-MA, or the like). Optionally, a similar method is also applicable to internal topology and state information of a mobile network of the CN network function/RAN network function. In another method, the first node may report the above information to the network controller. The first node functions as an information reporting agent for a node providing a service in the mobile network. On the one hand, there may be many nodes providing services in the mobile network, and message overhead of service information and computing information updates in a transmission network may be reduced by using aggregation via the first node. On the other hand, the node providing the service in the mobile network may use an internal IP address or the like in the mobile network, and the first node may convert an ID (such as an IP address) of the first node, to support completion of service interaction.

Optionally, before the first node provides the foregoing information, a solution in which the first node acquires the foregoing information is that the CN network function/RAN network function registers service information, which can be provided, to a first node computing service function. In addition, a computing load update message is sent to the first node according to an agreed computing load update condition (such as based on a timer, an event trigger, or a computing load change threshold). The process may specifically include the following steps:

Step 1: The CN network function/RAN function sends a service registration/update/deregistration/withdrawal message to the first node.

The foregoing message sent belongs to static or semi-static information with respect to the computing load information.

The message includes at least one of the following:
a service ID which is a unique ID that identifies a service, and may be an anycast IP address, or may be a predefined service ID (for example, a particular IPv4 address negotiated by the service node, the router, and the first node; and in another example, a MAC address or the like);
a service instance ID which is a unique ID that identifies a service instance, and may be a unicast IP address (for example, an internal IP address of the UE, an external IP address of the UE, or an IP address of an IMS server), or may be a MAC address, or may be an IP address, a port number, or the like;
a load value and a metric parameter corresponding to the load value, where the metric parameter is described in detail in the foregoing description, and details are not described herein again;
a service available time; and
a service available region.

The service available time and the service available region are both described in detail in the foregoing description, and details are not described herein again.

Optionally, the message sent in step 1 belongs to static or semi-static information with respect to the computing load information.

For example, the CN network function node sends service information and computing load information by using a CN service-based interface. When providing a service, the UPF may report the information to the SMF by using N4 interface extension. The SMF provides the information externally or the SMF sends the information to the new computing service management function in this embodiment. In another example, the radio access network node may report the service information to the new computing service management function via the AMF by using N2 interface extension.

Step 2: The CN network function/RAN function sends a computing load update message to the first node. The message includes at least one of the following:
a load value and a metric parameter corresponding to the load value, which may be, for simplicity of use, a single digital value, for example, a picture recognition service, calculated from a weighted attribute (such as CPU/GPU consumption and/or a quantity of related sessions), where a service provider may define a service load digital value by combining bandwidth resources, a quantity of requests, and computing resources; a computing load metric, which may alternatively be a group of parameters, including a CPU occupancy rate, a CPU idle rate, a service session occupancy rate, a service session idle rate, a quantity of used CPUs, a quantity of available CPUs, a quantity of used CPU cores, a quantity of available CPU cores, a quantity of used sessions, a quantity of available sessions, a computing delay, and used computing resources or available computing resources measured in Turing units, hash rates, TOPS/GOPS/MOPS, FLOPS, or the like; and
a service availability indication indicating whether the service is available.

Step 3: The first node sends obtained service information and computing load information of the CN network function/RAN function to a transmission device.

If the transmission device is an external network device, the first node needs to provide an external IP address of the CN network function/RAN function as a service instance ID provided by the CN network function/RAN function, and the information needs to be provided for a network external function by using a NEF or the like. Optionally, the first node may further provide an internal topology structure and a network transmission state of a mobile network corresponding to the CN network function/RAN function.

Optionally, the service information and the computing load information provided by the CN network function/RAN function may alternatively be provided for the transmission device by using the user plane node. Details are not described in this embodiment again.

In this embodiment of this application, the first node sends, to the non-mobile-communication-network function node, the service information and the computing load information of the service provided by the mobile-communication-network function node. Optionally, the first node further provides at least one of network topology structure information and a network transmission state of a mobile communication network to the non-mobile-communication-network function node, so that a CFN or CAN node may select a more appropriate service node according to the computing load information and transmission state information of the service. The solution is an efficient solution that supports computing-network integration in mobile networks based on extension of an international telecommunication union (ITU) solution in the related art. The first node functions as an information reporting agent for a node providing a service in the mobile network. On the one hand, there may be many nodes providing services in the mobile network, and message overhead of service information and computing information updates in a transmission network may be reduced by using aggregation via the first node. On the other hand, the node providing the service in the mobile network may use an internal IP address or the like in the mobile network, and the first node may convert an ID (such as an IP address) of the first node, to smoothly support completion of service interaction between different IP address domains.

It should be noted that this embodiment of this application is mainly applicable to a case in which a node sending a service request is the same as a node receiving a service response. If subsequent CFN/CAN extension supports a case in which the node sending the service request is different from the node receiving the service response, the solution of this application is also applicable. In addition, in this embodiment of this application, it is assumed that the CFN node, the D-MA, the D-Router, or the network controller has a capability of obtaining and/or using service information and computing load information outside the mobile network.

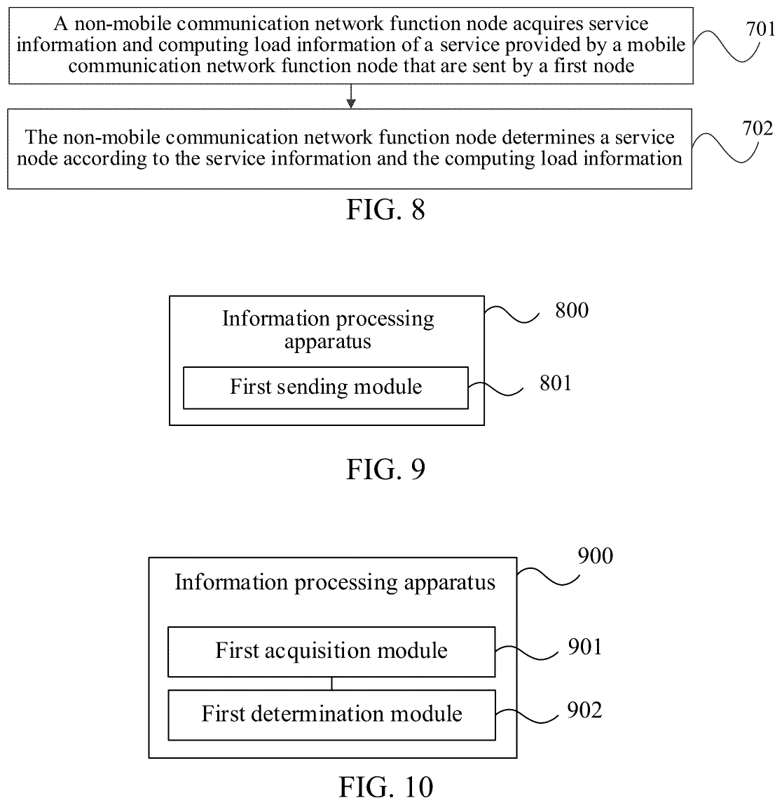

As shown in FIG. 8, an embodiment of this application further provides an information processing method, including the following steps:

Step 701: A non-mobile-communication-network function node acquires service information and computing load information of a service provided by a mobile-communication-network function node that are sent by a first node.

Step 702: The non-mobile-communication-network function node determines a service node according to the service information and the computing load information.

In this embodiment of this application, the non-mobile-communication-network function node acquires the service information and the computing load information of the service provided by the mobile-communication-network function node that are sent by the first node; and the non-mobile-communication-network function node determines the service node according to the service information and the computing load information. In this embodiment of this application, the non-mobile-communication-network function node no longer selects a service node based on only service information and computing load information of a service provided by the non-mobile-communication-network function node, but can select a more appropriate service node based on the service information and the computing load information of the service provided by the mobile-communication-network function node and the service information and the computing load information of the service provided by the non-mobile-communication-network function node. That is, the selection of the service node integrates the service information and the computing load information corresponding to two networks, i.e., a mobile communication network and a non-mobile communication network. A service provided by the service node may be the service provided by the mobile-communication-network function node or may be the service provided by the non-mobile-communication-network function node.

Optionally, the service information includes at least one of the following: at least one of a service ID and a service instance ID, where the service ID is used for identifying a service, the service instance ID is used for identifying a service instance providing the service, and the service instance corresponds to the service node;
and/or, the computing load information includes at least one of the following:
a load value;
a metric parameter corresponding to the load value;
a service available time; and
a service available region.

Optionally, the method in this embodiment of this application further includes:
acquiring, by the non-mobile-communication-network function node, at least one of network topology structure information and a network transmission state of a mobile communication network;
where the network topology structure information is information of a network topology structure between the mobile-communication-network function node providing the service and a target node;
where the target node is a node that receives service data sent by a service request sending node.

Optionally, the determining, by the non-mobile-communication-network function node, a service node according to the service information and the computing load information includes:
determining, by the non-mobile-communication-network function node, a service node according to at least one of the network topology structure information and the network transmission state, the service information, and the computing load information.

Optionally, in a case that the mobile-communication-network function node providing the service is a terminal device:
the network topology structure information includes at least one of the following: a serving base station of the terminal device; a target node transmitting a first PDU session; where the first PDU session is a PDU session corresponding to a service request;
and/or the network transmission state includes at least one of the following:
an uplink transmission delay between the terminal device and the base station;
a downlink transmission delay between the terminal device and the base station;
a round-trip transmission delay between the terminal device and the base station;
an uplink transmission delay between the base station and the target node;
a downlink transmission delay between the base station and the target node;
a round-trip transmission delay between the base station and the target node;
an uplink bandwidth between the terminal device and the base station;
a downlink bandwidth between the terminal device and the base station;
an uplink bandwidth between the terminal device and the target node; and
a downlink bandwidth between the terminal device and the target node.

Optionally, in a case that the mobile-communication-network function node providing the service is an IMS function node, a trusted DN DN node, a CN network function node, or a RAN network function node:
the network topology structure information includes: the first node connected to the mobile-communication-network function node providing the service;
and/or the network transmission state includes at least one of the following:
an uplink transmission delay between a target node and the mobile-communication-network function node providing the service;
a downlink transmission delay between the target node and the mobile-communication-network function node providing the service; and
a round-trip transmission delay between the target node and the mobile-communication-network function node providing the service.

Optionally, the acquiring, by a non-mobile-communication-network function node, service information and computing load information of a service provided by a mobile-communication-network function node that are sent by a first node includes:
acquiring, by the non-mobile-communication-network function node by using a service registration message, a service update message, a service deregistration message, or a service withdrawal message, the service information and the computing load information of the service provided by the mobile-communication-network function node that are sent by the first node.

Optionally, the method in this embodiment of this application further includes:
acquiring update information of the computing load information sent by the first node.

Optionally, the non-mobile-communication-network function node includes a CFN node, a CAN node, a network controller, a D-MA node, or a D-Router node.

It should be noted that the information processing method performed by the non-mobile-communication-network function node is a method corresponding to the foregoing information processing method performed by the first node, and details are not described herein again.

In this embodiment of this application, the non-mobile-communication-network function node acquires the service information and the computing load information of the service provided by the mobile-communication-network function node that are sent by the first node; and the non-mobile-communication-network function node determines the service node according to the service information and the computing load information. In this embodiment of this application, the non-mobile-communication-network function node no longer selects a service node based on only service information and computing load information of a service provided by the non-mobile-communication-network function node, but can select a more appropriate service node based on the service information and the computing load information of the service provided by the mobile-communication-network function node and the service information and the computing load information of the service provided by the non-mobile-communication-network function node. That is, the selection of the service node integrates the service information and the computing load information corresponding to two networks, i.e., a mobile communication network and a non-mobile communication network. A service provided by the service node may be the service provided by the mobile-communication-network function node or may be the service provided by the non-mobile-communication-network function node.

The information processing method provided in the embodiments of this application may be performed by an information processing apparatus. In this embodiment of this application, an information processing apparatus provided in this embodiment of this application is described with an example in which the information processing apparatus performs the information processing method.

As shown in FIG. 9, an embodiment of this application further provides an information processing apparatus 800, applied to a first node. The apparatus includes:
a first sending module 801, configured to send, to a non-mobile-communication-network function node, service information and computing load information of a service provided by a mobile-communication-network function node, the service information and the computing load information being used by the non-mobile-communication-network function node to determine a service node.

Optionally, the service information includes at least one of the following:
at least one of a service ID and a service instance ID, where the service ID is used for identifying a service, the service instance ID is used for identifying a service instance providing the service, and the service instance corresponds to the service node;
and/or, the computing load information includes at least one of the following:
a load value;
a metric parameter corresponding to the load value;
a service available time; and
a service available region.

Optionally, the apparatus in this embodiment of this application further includes:
a second sending module, configured to send at least one of network topology structure information and a network transmission state of a mobile communication network to the non-mobile-communication-network function node;
where the network topology structure information is information of a network topology structure between the mobile-communication-network function node providing the service and the first node.

Optionally, in a case that the mobile-communication-network function node providing the service is a terminal device:
the network topology structure information includes at least one of the following: a serving base station of the terminal device; a target node transmitting a first PDU session; where the first PDU session is a PDU session corresponding to a service request;
and/or the network transmission state includes at least one of the following:
an uplink transmission delay between the terminal device and the base station;
a downlink transmission delay between the terminal device and the base station;
a round-trip transmission delay between the terminal device and the base station;
an uplink transmission delay between the base station and the target node;
a downlink transmission delay between the base station and the target node;
a round-trip transmission delay between the base station and the target node;
an uplink bandwidth between the terminal device and the base station;
a downlink bandwidth between the terminal device and the base station;
an uplink bandwidth between the terminal device and the target node; and
a downlink bandwidth between the terminal device and the target node;
where the target node is a node that receives service data sent by a service request sending node.

Optionally, in a case that the mobile-communication-network function node providing the service is an IMS function node, a trusted DN node, a CN network function node, or a RAN network function node:
the network topology structure information includes: the first node connected to the mobile-communication-network function node providing the service;
and/or the network transmission state includes at least one of the following:
an uplink transmission delay between a target node and the mobile-communication-network function node providing the service;
a downlink transmission delay between the target node and the mobile-communication-network function node providing the service; and
a round-trip transmission delay between the target node and the mobile-communication-network function node providing the service;
where the target node is a node that receives service data sent by a service request sending node.

Optionally, the apparatus in this embodiment of this application further includes:
a second acquisition module, configured to acquire the service information and the computing load information of the service provided by the mobile-communication-network function node.

Optionally, the second acquisition module is configured to acquire, from a second node, the service information and the computing load information of the service provided by the mobile-communication-network function node, and the second node is the mobile-communication-network function node.

Optionally, the second acquisition module is configured to acquire the service information and the computing load information by using an extended session management message, a service registration message, a service update message, a service deregistration message, or a service withdrawal message.

Optionally, the first sending module is configured to send the service information and the computing load information to the non-mobile-communication-network function node by using a service registration message, a service update message, a service deregistration message, or a service withdrawal message.

Optionally, the apparatus in this embodiment of this application further includes:
a third sending module, configured to send update information of the computing load information to the non-mobile-communication-network function node according to a load information update condition.

Optionally, the first node includes a control plane node or a user plane node in a mobile communication network.

In this embodiment of this application, the first node sends, to the non-mobile-communication-network function node, the service information and the computing load information of the service provided by the mobile-communication-network function node, so that the non-mobile-communication-network function node no longer selects a service node based on only service information and computing load information of a service provided by the non-mobile-communication-network function node, but can select a more appropriate service node based on the service information and the computing load information of the service provided by the mobile-communication-network function node and the service information and the computing load information of the service provided by the non-mobile-communication-network function node. That is, the selection of the service node integrates the service information and the computing load information corresponding to two networks, i.e., a mobile communication network and a non-mobile communication network. A service provided by the service node may be the service provided by the mobile-communication-network function node or may be the service provided by the non-mobile-communication-network function node.

As shown in FIG. 10, an embodiment of this application further provides an information processing apparatus 900, applied to a non-mobile communication network function node. The apparatus includes:
a first acquisition module 901, configured to acquire service information and computing load information of a service provided by a mobile-communication-network function node that are sent by a first node; and
a first determination module 902, configured to determine a service node according to the service information and the computing load information.

Optionally, the service information includes at least one of the following: at least one of a service ID and a service instance ID, where the service ID is used for identifying a service, the service instance ID is used for identifying a service instance providing the service, and the service instance corresponds to the service node;
and/or, the computing load information includes at least one of the following:
a load value;
a metric parameter corresponding to the load value;
a service available time; and
a service available region.

Optionally, the apparatus in this embodiment of this application further includes:
a third acquisition module, configured to acquire at least one of network topology structure information and a network transmission state of a mobile communication network;
where the network topology structure information is information of a network topology structure between the mobile-communication-network function node providing the service and a target node;
where the target node is a node that receives service data sent by a service request sending node.

Optionally, the first determination module is configured to determine a service node according to at least one of the network topology structure information and the network transmission state, the service information, and the computing load information.

Optionally, in a case that the mobile-communication-network function node providing the service is a terminal device:
the network topology structure information includes at least one of the following: a serving base station of the terminal device; a target node transmitting a first PDU session; where the first PDU session is a PDU session corresponding to a service request;
and/or the network transmission state includes at least one of the following:
an uplink transmission delay between the terminal device and the base station;
a downlink transmission delay between the terminal device and the base station;
a round-trip transmission delay between the terminal device and the base station;
an uplink transmission delay between the base station and the target node;
a downlink transmission delay between the base station and the target node;
a round-trip transmission delay between the base station and the target node;
an uplink bandwidth between the terminal device and the base station;
a downlink bandwidth between the terminal device and the base station;
an uplink bandwidth between the terminal device and the target node; and
a downlink bandwidth between the terminal device and the target node.

Optionally, in a case that the mobile-communication-network function node providing the service is an IMS function node, a trusted DN node, a CN network function node, or a RAN network function node:
the network topology structure information includes: the first node connected to the mobile-communication-network function node providing the service;
and/or the network transmission state includes at least one of the following:
an uplink transmission delay between a target node and the mobile-communication-network function node providing the service;
a downlink transmission delay between the target node and the mobile-communication-network function node providing the service; and
a round-trip transmission delay between the target node and the mobile-communication-network function node providing the service.

Optionally, the first acquisition module is configured to acquire, by using a service registration message, a service update message, a service deregistration message, or a service withdrawal message, the service information and the computing load information of the service provided by the mobile-communication-network function node that are sent by the first node.

Optionally, the apparatus in this embodiment of this application further includes:
a fourth acquisition module, configured to acquire update information of the computing load information sent by the first node.

Optionally, the non-mobile-communication-network function node includes a CFN node, a CAN node, a network controller, a D-MA node, or a D-Router node.

In this embodiment of this application, the non-mobile-communication-network function node acquires the service information and the computing load information of the service provided by the mobile-communication-network function node that are sent by the first node; and the non-mobile-communication-network function node determines the service node according to the service information and the computing load information. In this embodiment of this application, the non-mobile-communication-network function node no longer selects a service node based on only service information and computing load information of a service provided by the non-mobile-communication-network function node, but can select a more appropriate service node based on the service information and the computing load information of the service provided by the mobile-communication-network function node and the service information and the computing load information of the service provided by the non-mobile-communication-network function node. That is, the selection of the service node integrates the service information and the computing load information corresponding to two networks, i.e., a mobile communication network and a non-mobile communication network. A service provided by the service node may be the service provided by the mobile-communication-network function node or may be the service provided by the non-mobile-communication-network function node.

The information processing apparatus in this embodiment of this application may be an electronic device, for example, an electronic device with an operating system, or may be a component in an electronic device, for example, an integrated circuit or chip. The electronic device may be a terminal, or may be another device other than a terminal. For example, the terminal may include, but is not limited to, the above listed types of the terminal 11, and the another device may be a server, a network attached storage (NAS), or the like, which is not specifically limited in the embodiments of this application.

The resource processing apparatus according to this embodiment of this application can implement processes implemented in the method embodiments shown in FIG. 4 to FIG. 7. To avoid repetition, details are not described herein again.

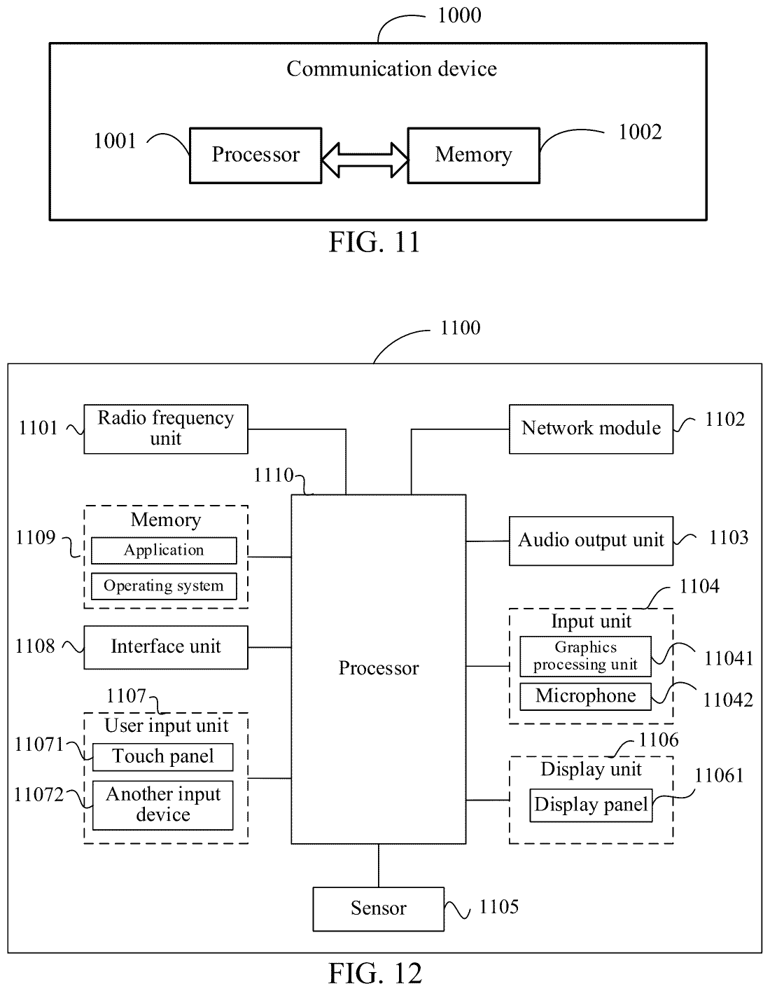

Optionally, as shown in FIG. 11, an embodiment of this application further provides a communication device 1000, including a processor 1001 and a memory 1002. The memory 1002 has a program or an instruction executable on the processor 1001 stored therein. For example, when the communication device 1000 is a first node, the program or the instruction is executed by the processor 1001 to implement the steps in the embodiments of the information processing method performed by the first node, and the same technical effects can be achieved. When the communication device 1000 is a non-mobile-communication-network function node, the program or the instruction is executed by the processor 1001 to implement the steps in the embodiments of the information processing method performed by the non-mobile-communication-network function node, and the same technical effects can be achieved. To avoid repetition, details are not described herein again.

An embodiment of this application further provides a terminal, including a processor and a communication interface. The communication interface is used for sending, to a non-mobile-communication-network function node, service information and computing load information of a service provided by a mobile-communication-network function node. The service information and the computing load information are used by the non-mobile-communication-network function node to determine a service node. The terminal embodiment corresponds to the foregoing method embodiment of the first node side. Implementation processes and implementations of the foregoing method embodiment are all applicable to the terminal embodiment, and the same technical effects can be achieved. Specifically, FIG. 12 is a schematic diagram of a hardware structure of a terminal implementing an embodiment of this application.

The terminal 1100 includes, but is not limited to, at least some components in a radio frequency unit 1101, a network module 1102, an audio output unit 1103, an input unit 1104, a sensor 1105, a display unit 1106, a user input unit 1107, an interface unit 1108, a memory 1109, a processor 1110, and the like.

A person skilled in the art may understand that the terminal 1100 may further include a power supply (such as a battery) for supplying power to the components. The power supply may logically connect to the processor 1110 by using a power supply management system, thereby implementing functions, such as charging, discharging, and power consumption management, by using the power supply management system. The terminal structure shown in FIG. 12 does not constitute a limitation on the terminal, and the terminal may include components more or fewer than the components shown in the figure, or combine some components, or have different component arrangements. Details are not described herein again.

It should be understood that, in this embodiment of this application, the input unit 1104 may include a GPU 11041 and a microphone 11042. The GPU 11041 processes image data of still pictures or videos captured by an image capture apparatus (such as a camera) in a video capture mode or an image capture mode. The display unit 1106 may include a display panel 11061. The display panel 11061 may be configured in a form of a liquid crystal display, an organic light-emitting diode, or the like. The user input unit 1107 includes at least one of a touch panel 11071 and another input device 11072. The touch panel 11071 is also referred to as a touchscreen. The touch panel 11071 may include two parts: a touch detection apparatus and a touch controller. The another input device 11072 may include, but is not limited to, a physical keyboard, a function key (such as a volume control key or an on/off key), a trackball, a mouse, and a joystick. Details are not described herein again.

In this embodiment of this application, after receiving downlink data from a network-side device, the radio frequency unit 1101 may transmit the downlink data to the processor 1110 for processing. In addition, the radio frequency unit 1101 may send uplink data to the network-side device. Generally, the radio frequency unit 1101 includes, but is not limited to, an antenna, an amplifier, a transceiver, a coupler, a low noise amplifier, a duplexer, and the like.

The memory 1109 may be configured to store a software program or instructions and various data. The memory 1109 may mainly include a first storage region for storing a program or an instruction and a second storage region for storing data. The first storage region may store an operating system, an application or instruction required by at least one function (such as a sound playback function and an image playback function), or the like. In addition, the memory 1109 may include a volatile memory or a non-volatile memory, or the memory 1109 may include both a volatile memory and a non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM), a static RAM (SRAM), a dynamic RAM (DRAM), a synchronous DRAM (SDRAM), a double data rate SDRAM (DDRSDRAM), an enhanced SDRAM (ESDRAM), a synchronous link DRAM (SLDRAM), or a direct rambus RAM (DRRAM). The memory 1109 in this embodiment of this application includes, but is not limited to, these and any other suitable types of memories.

The processor 1110 may include one or more processing units. Optionally, the processor 1110 integrates an application processor and a modem processor. The application processor mainly processes operations related to an operating system, a user interface, and an application. The modem processor mainly processes a wireless communication signal, such as a baseband processor. It may be understood that the foregoing modem may not be integrated into the processor 1110.

In an embodiment of this application, the radio frequency unit 1101 is configured to send, to a non-mobile-communication-network function node, service information and computing load information of a service provided by a mobile-communication-network function node, and the service information and the computing load information are used by the non-mobile-communication-network function node to determine a service node.

Optionally, the service information includes at least one of the following:
at least one of a service ID and a service instance ID, where the service ID is used for identifying a service, the service instance ID is used for identifying a service instance providing the service, and the service instance corresponds to the service node;
and/or, the computing load information includes at least one of the following:
a load value;
a metric parameter corresponding to the load value;
a service available time; and
a service available region.

Optionally, the radio frequency unit 1101 is further configured to:
send at least one of network topology structure information and a network transmission state of a mobile communication network to the non-mobile-communication-network function node;
where the network topology structure information is information of a network topology structure between the mobile-communication-network function node providing the service and the first node.

Optionally, in a case that the mobile-communication-network function node providing the service is a terminal device:
the network topology structure information includes at least one of the following: a serving base station of the terminal device; a target node transmitting a first PDU session; where the first PDU session is a PDU session corresponding to a service request;
and/or the network transmission state includes at least one of the following:
an uplink transmission delay between the terminal device and the base station;
a downlink transmission delay between the terminal device and the base station;
a round-trip transmission delay between the terminal device and the base station;
an uplink transmission delay between the base station and the target node;
a downlink transmission delay between the base station and the target node;
a round-trip transmission delay between the base station and the target node;
an uplink bandwidth between the terminal device and the base station;
a downlink bandwidth between the terminal device and the base station;
an uplink bandwidth between the terminal device and the target node; and
a downlink bandwidth between the terminal device and the target node;
where the target node is a node that receives service data sent by a service request sending node.

Optionally, in a case that the mobile-communication-network function node providing the service is an IMS function node, a trusted DN node, a CN network function node, or a RAN network function node:
the network topology structure information includes: the first node connected to the mobile-communication-network function node providing the service;
and/or the network transmission state includes at least one of the following:
an uplink transmission delay between a target node and the mobile-communication-network function node providing the service;
a downlink transmission delay between the target node and the mobile-communication-network function node providing the service; and
a round-trip transmission delay between the target node and the mobile-communication-network function node providing the service;
where the target node is a node that receives service data sent by a service request sending node.

Optionally, the radio frequency unit 1101 is further configured to:
acquire the service information and the computing load information of the service provided by the mobile-communication-network function node.

Optionally, the radio frequency unit 1101 is further configured to: acquire, from a second node, the service information and the computing load information of the service provided by the mobile-communication-network function node, and the second node is the mobile-communication-network function node.

Optionally, the radio frequency unit 1101 is further configured to: acquire, by the first node, the service information and the computing load information by using an extended session management message, a service registration message, a service update message, a service deregistration message, or a service withdrawal message.

Optionally, the radio frequency unit 1101 is further configured to: send the service information and the computing load information to the non-mobile-communication-network function node by using a service registration message, a service update message, a service deregistration message, or a service withdrawal message.

Optionally, the radio frequency unit 1101 is further configured to: send update information of the computing load information to the non-mobile-communication-network function node according to a load information update condition.

Optionally, the first node includes a control plane node or a user plane node in a mobile communication network.

In an embodiment of this application, the radio frequency unit 1101 is configured to: acquire service information and computing load information of a service provided by a mobile-communication-network function node that are sent by a first node; and the processor 1110 is configured to determine a service node according to the service information and the computing load information.

Optionally, the service information includes at least one of the following: at least one of a service ID and a service instance ID, where the service ID is used for identifying a service, the service instance ID is used for identifying a service instance providing the service, and the service instance corresponds to the service node;
and/or, the computing load information includes at least one of the following:
a load value;
a metric parameter corresponding to the load value;
a service available time; and
a service available region.

Optionally, the radio frequency unit 1101 is further configured to:
acquire at least one of network topology structure information and a network transmission state of a mobile communication network;
where the network topology structure information is information of a network topology structure between the mobile-communication-network function node providing the service and a target node;
where the target node is a node that receives service data sent by a service request sending node.

Optionally, the processor 1110 is further configured to: determine a service node according to at least one of the network topology structure information and the network transmission state, the service information, and the computing load information.

Optionally, in a case that the mobile-communication-network function node providing the service is a terminal device:
the network topology structure information includes at least one of the following: a serving base station of the terminal device; a target node transmitting a first PDU session; where the first PDU session is a PDU session corresponding to a service request;
and/or the network transmission state includes at least one of the following:
an uplink transmission delay between the terminal device and the base station;
a downlink transmission delay between the terminal device and the base station;
a round-trip transmission delay between the terminal device and the base station;
an uplink transmission delay between the base station and the target node;
a downlink transmission delay between the base station and the target node;
a round-trip transmission delay between the base station and the target node;
an uplink bandwidth between the terminal device and the base station;
a downlink bandwidth between the terminal device and the base station;
an uplink bandwidth between the terminal device and the target node; and
a downlink bandwidth between the terminal device and the target node.

Optionally, in a case that the mobile-communication-network function node providing the service is an IMS function node, a trusted DN node, a CN network function node, or a RAN network function node:
the network topology structure information includes: the first node connected to the mobile-communication-network function node providing the service;
and/or the network transmission state includes at least one of the following:
an uplink transmission delay between a target node and the mobile-communication-network function node providing the service;
a downlink transmission delay between the target node and the mobile-communication-network function node providing the service; and
a round-trip transmission delay between the target node and the mobile-communication-network function node providing the service.

Optionally, the radio frequency unit 1101 is further configured to: acquire, by using a service registration message, a service update message, a service deregistration message, or a service withdrawal message, the service information and the computing load information of the service provided by the mobile-communication-network function node that are sent by the first node.

Optionally, the radio frequency unit 1101 is further configured to:
acquire update information of the computing load information sent by the first node.

Optionally, the non-mobile-communication-network function node includes a CFN node, a CAN node, a network controller, a D-MA node, or a D-Router node.

In this embodiment of this application, the first node sends, to the non-mobile-communication-network function node, the service information and the computing load information of the service provided by the mobile-communication-network function node, which achieves a purpose of sharing the service information and the computing load information that are provided by the mobile-communication-network function node with the mobile network external node, so that the non-mobile-communication-network function node no longer selects a service node based on only service information and computing load information of a service provided by the non-mobile-communication-network function node, but can select a more appropriate service node based on the service information and the computing load information of the service provided by the mobile-communication-network function node and the service information and the computing load information of the service provided by the non-mobile-communication-network function node. That is, the selection of the service node integrates the service information and the computing load information corresponding to two networks, i.e., a mobile communication network and a non-mobile communication network. A service provided by the service node may be the service provided by the mobile-communication-network function node or may be the service provided by the non-mobile-communication-network function node.

An embodiment of this application further provides a network-side device, including a processor and a communication interface. The communication interface is used for sending, to a non-mobile-communication-network function node, service information and computing load information of a service provided by a mobile-communication-network function node. The service information and the computing load information are used by the non-mobile-communication-network function node to determine a service node. Alternatively, the communication interface is used for acquiring service information and computing load information of a service provided by a mobile-communication-network function node that are sent by a first node; and the processor is configured to determine a service node according to the service information and the computing load information.

The embodiment of the network-side device corresponds to the foregoing embodiment of the information processing method, and the various implementation processes and implementations of the foregoing method embodiment are applicable to the embodiment of the network-side device, and the same technical effects can be achieved.

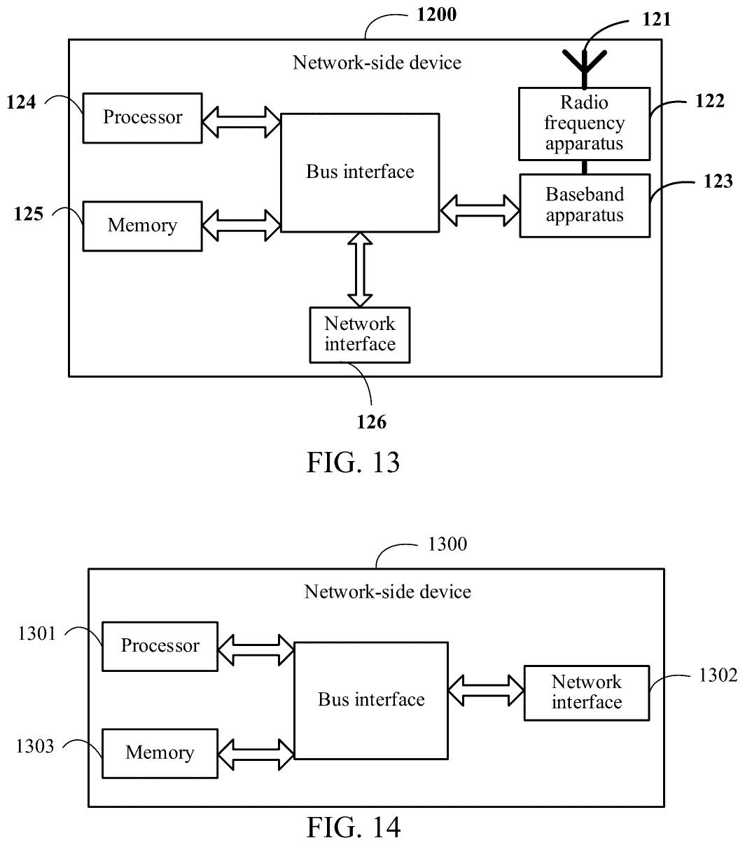

Specifically, an embodiment of this application further provides a network-side device. As shown in FIG. 13, the network-side device 1200 includes: an antenna 121, a radio frequency apparatus 122, a baseband apparatus 123, a processor 124, and a memory 125. The antenna 121 is connected to the radio frequency apparatus 122. In an uplink direction, the radio frequency apparatus 122 receives information by using the antenna 121, and sends the received information to the baseband apparatus 123 for processing. In a downlink direction, the baseband apparatus 123 processes information to be sent and sends the information to the radio frequency apparatus 122. The radio frequency apparatus 122 processes the received information and then sends the information by using the antenna 121.

In the above embodiments, the method performed by the first node or the non-mobile-communication-network function node may be implemented in the baseband apparatus 123. The baseband apparatus 123 includes a baseband processor.

For example, the baseband apparatus 123 may include at least one baseband board, and a plurality of chips are arranged on the baseband board. As shown in FIG. 13, one of the chips is, for example, a baseband processor, and is connected to the memory 125 by using a bus interface, so as to invoke a program in the memory 125 to perform the operations shown in the above method embodiment.

The network-side device may further include a network interface 126. The interface is, for example, a common public radio interface (CPRI).

Specifically, the network-side device 1200 in this embodiment of this application further includes: an instruction or a program stored in the memory 125 and executable on the processor 124. The processor 124 invokes the instruction or the program in the memory 125 to perform the method performed by the modules shown in FIG. 9 or FIG. 10, and the same technical effects are achieved. To avoid repetition, details are not described herein.

Specifically, an embodiment of this application further provides a network-side device. As shown in FIG. 14, the network-side device 1300 includes: a processor 1301, a network interface 1302, and a memory 1303. The network interface 1302 is, for example, a CPRI.

Specifically, the network-side device 1300 in this embodiment of this application further includes: an instruction or a program stored in the memory 1303 and executable on the processor 1301. The processor 1301 invokes the instruction or the program in the memory 1303 to perform the method performed by the modules shown in FIG. 9 or FIG. 10, and the same technical effect is achieved. To avoid repetition, details are not described herein.

An embodiment of this application further provides a readable storage medium. The readable storage medium has a program or an instruction stored therein. When the program or the instruction is executed by a processor, various processes in the foregoing embodiment of the information processing method are implemented, and the same technical effects can be achieved. To avoid repetition, details are not described herein again.

The processor may be a processor of the terminal in the foregoing embodiments. The readable storage medium includes a computer-readable storage medium, for example, a computer ROM, a RAM, a magnetic disk, an optical disk, or the like.

An embodiment of this application further provides a chip. The chip includes a processor and a communication interface. The communication interface is coupled to the processor. The processor is configured to run a program or an instruction to implement various processes in the foregoing method of the information processing method, and the same technical effects can be achieved. To avoid repetition, details are not described herein again.

It will be appreciated that the chip mentioned in this embodiment of this application may also be referred to as a system on chip, a system chip, a system on a chip, a system-on-a-chip, or the like.

An embodiment of this application further provides a computer program/program product. The computer program/program product is stored in a storage medium. When the computer program/program product is executed by at least one processor, various processes in the foregoing embodiment of the information processing method are implemented, and the same technical effect can be achieved. To avoid repetition, details are not described herein.

An embodiment of this application further provides an information processing system, including: a first node and a non-mobile-communication-network function node. The first node may be configured to perform steps of the information processing method performed by the first node as described above, and the non-mobile-communication-network function node may be configured to perform steps of the information processing method performed by the non-mobile-communication-network function node as described above.

It should be noted that the terms “include”, “comprise”, or any other variations thereof herein are intended to cover a non-exclusive inclusion, such that a process, method, article, or apparatus including a series of elements not only includes those elements, but also includes other elements that are not explicitly listed, or also includes elements inherent to the process, method, article, or apparatus. Without more restrictions, the elements defined by the sentence “including/comprising a/an . . . ” do not exclude existence of other identical elements in the process, the method, the article, or the apparatus including the elements. Moreover, it should be noted that the scope of the method and the apparatus in the implementations of this application is not limited to performing functions in the order shown or discussed, but may include performing functions in a substantially concurrent manner or in reverse order depending on the functionality involved. For example, the method described may be performed in an order different from that described, and various steps may also be added, omitted, or combined. Moreover, features described with reference to some examples may be combined in other examples.

According to the descriptions in the foregoing implementations, a person skilled in the art may clearly learn that the method in the foregoing embodiment may be implemented by relying on software plus a necessary general hardware platform or by using hardware. In most cases, the former is preferred. Based on such understanding, the technical solution of this application, in essence or from the view of the part contributing to the related art, may be embodied in a form of a computer software product. The computer software product is stored in a storage medium (such as a ROM/RAM, a magnetic disk, and an optical disk) and includes several instructions configured to enable a terminal (which may be a mobile phone, a computer, a server, an air conditioner, a network device, or the like) to perform the method according to the embodiments of this application.

Embodiments of this application are described above with reference to the accompanying drawings. However, this application is not limited to the foregoing specific implementations. The foregoing specific implementations are only illustrative rather than restrictive. Inspired by this application, a person of ordinary skill in the art can still derive a plurality of variations without departing from the essence of this application and the protection scope of the claims. All these variations shall fall within the protection of this application.

What is claimed is:

1. An information processing method, comprising:
sending, by a first node to a non-mobile-communication-network function node, service information and computing load information of a service provided by a mobile-communication-network function node, the service information and the computing load information being used by the non-mobile-communication-network function node to determine a service node.

2. The method according to claim 1, wherein the service information comprises at least one of the following:
at least one of a service identification (ID) or a service instance ID, wherein the service ID is used for identifying a service, and the service instance ID is used for identifying a service instance providing the service, the service instance corresponding to the service node;
and/or, the computing load information comprises at least one of the following:
a load value;
a metric parameter corresponding to the load value;
a service available time; or
a service available region.

3. The method according to claim 1, further comprising:
sending, by the first node, at least one of network topology structure information or a network transmission state of a mobile communication network to the non-mobile-communication-network function node;
wherein the network topology structure information is information of a network topology structure between the mobile-communication-network function node providing the service and the first node.

4. The method according to claim 3, wherein in a case that the mobile-communication-network function node providing the service is a terminal device:
the network topology structure information comprises at least one of the following: a serving base station of the terminal device; or a target node transmitting a first protocol data unit (PDU) session; wherein the first PDU session is a PDU session corresponding to a service request;
and/or the network transmission state comprises at least one of the following:
an uplink transmission delay between the terminal device and the base station;
a downlink transmission delay between the terminal device and the base station;
a round-trip transmission delay between the terminal device and the base station;
an uplink transmission delay between the base station and the target node;
a downlink transmission delay between the base station and the target node;
a round-trip transmission delay between the base station and the target node;
an uplink bandwidth between the terminal device and the base station;
a downlink bandwidth between the terminal device and the base station;
an uplink bandwidth between the terminal device and the target node; or
a downlink bandwidth between the terminal device and the target node;
wherein the target node is a node that receives service data sent by a service request sending node.

5. The method according to claim 3, wherein in a case that the mobile-communication-network function node providing the service is an IP multimedia subsystem (IMS) function node, a trusted data network (DN) node, a core network (CN) network function node, or a radio access network (RAN) network function node:
the network topology structure information comprises: the first node connected to the mobile-communication-network function node providing the service;
and/or the network transmission state comprises at least one of the following:
an uplink transmission delay between a target node and the mobile-communication-network function node providing the service;
a downlink transmission delay between the target node and the mobile-communication-network function node providing the service; or
a round-trip transmission delay between the target node and the mobile-communication-network function node providing the service;
wherein the target node is a node that receives service data sent by a service request sending node.

6. The method according to claim 1, further comprising:
acquiring, by the first node, the service information and the computing load information of the service provided by the mobile-communication-network function node.

7. The method according to claim 6, wherein the acquiring, by the first node, the service information and the computing load information of the service provided by the mobile-communication-network function node comprises:
acquiring, by the first node from a second node, the service information and the computing load information of the service provided by the mobile-communication-network function node, the second node being the mobile-communication-network function node.

8. The method according to claim 6, wherein the acquiring, by the first node, the service information and the computing load information of the service provided by the mobile-communication-network function node comprises:
acquiring, by the first node, the service information and the computing load information by using an extended session management message, a service registration message, a service update message, a service deregistration message, or a service withdrawal message.

9. The method according to claim 1, wherein the sending, by a first node to a non-mobile-communication-network function node, service information and computing load information of a service provided by a mobile-communication-network function node comprises:
sending, by the first node, the service information and the computing load information to the non-mobile-communication-network function node by using a service registration message, a service update message, a service deregistration message, or a service withdrawal message.

10. The method according to claim 1, further comprising:
sending update information of the computing load information to the non-mobile-communication-network function node according to a load information update condition; and/or,
wherein the first node comprises a control plane node or a user plane node in the mobile communication network.

11. An information processing method, comprising:
acquiring, by a non-mobile-communication-network function node, service information and computing load information of a service provided by a mobile-communication-network function node that are sent by a first node; and
determining, by the non-mobile-communication-network function node, a service node according to the service information and the computing load information.

12. The method according to claim 11, wherein the service information comprises at least one of the following: at least one of a service ID or a service instance ID, wherein the service ID is used for identifying a service, and the service instance ID is used for identifying a service instance providing the service, the service instance corresponding to the service node;
and/or, the computing load information comprises at least one of the following:
a load value;
a metric parameter corresponding to the load value;
a service available time; or
a service available region.

13. The method according to claim 11, further comprising:
acquiring, by the non-mobile-communication-network function node, at least one of network topology structure information or a network transmission state of a mobile communication network;
wherein the network topology structure information is information of a network topology structure between the mobile-communication-network function node providing the service and a target node;
wherein the target node is a node that receives service data sent by a service request sending node.

14. The method according to claim 13, wherein the determining, by the non-mobile-communication-network function node, a service node according to the service information and the computing load information comprises:
determining, by the non-mobile-communication-network function node, a service node according to at least one of the network topology structure information and the network transmission state, the service information, or the computing load information.

15. The method according to claim 13, wherein in a case that the mobile-communication-network function node providing the service is a terminal device:
the network topology structure information comprises at least one of the following: a serving base station of the terminal device; or a target node transmitting a first PDU session; wherein the first PDU session is a PDU session corresponding to a service request;
and/or the network transmission state comprises at least one of the following:
an uplink transmission delay between the terminal device and the base station;
a downlink transmission delay between the terminal device and the base station;
a round-trip transmission delay between the terminal device and the base station;
an uplink transmission delay between the base station and the target node;
a downlink transmission delay between the base station and the target node;
a round-trip transmission delay between the base station and the target node;
an uplink bandwidth between the terminal device and the base station;
a downlink bandwidth between the terminal device and the base station;
an uplink bandwidth between the terminal device and the target node; or
a downlink bandwidth between the terminal device and the target node.

16. The method according to claim 13, wherein in a case that the mobile-communication-network function node providing the service is an IMS function node, a trusted DN node, a CN network function node, or a RAN network function node:
the network topology structure information comprises: the first node connected to the mobile-communication-network function node providing the service;
and/or the network transmission state comprises at least one of the following:
an uplink transmission delay between a target node and the mobile-communication-network function node providing the service;
a downlink transmission delay between the target node and the mobile-communication-network function node providing the service; or
a round-trip transmission delay between the target node and the mobile-communication-network function node providing the service.

17. The method according to claim 11, wherein the acquiring, by a non-mobile-communication-network function node, service information and computing load information of a service provided by a mobile-communication-network function node that are sent by a first node comprises:
acquiring, by the non-mobile-communication-network function node by using a service registration message, a service update message, a service deregistration message, or a service withdrawal message, the service information and the computing load information of the service provided by the mobile-communication-network function node that are sent by the first node.

18. The method according to claim 11, further comprising:
acquiring update information of the computing load information sent by the first node; and/or,
wherein the non-mobile-communication-network function node comprises a compute first networking (CFN) node, a computing-aware networking (CAN) node, a network controller, a dyncast metric agent (D-MA) node, or a dynamic router (D-Router) node.

19. A communication device, comprising a processor and a memory, the memory storing a program or an instruction executable on the processor, wherein the program or the instruction, when executed by the processor, causes the communication device to perform:
sending, to a non-mobile-communication-network function node, service information and computing load information of a service provided by a mobile-communication-network function node, the service information and the computing load information being used by the non-mobile-communication-network function node to determine a service node.

20. A communication device, comprising a processor and a memory, the memory storing a program or an instruction executable on the processor, and when the program or the instruction is executed by the processor, steps of the information processing method according to claim 11 being implemented.
